(19) United States
(12) Patent Application Publication
(10) Pub. No.: US 2010/0194798 A1
(43) Pub. Date: Aug. 5, 2010

(54) INKJET PRINTER AND INK CIRCULATION METHOD THEREOF

(75) Inventors: Keiichi ASAMI, Tokyo (JP); Taiki Yashima, Tokyo (JP)

Correspondence Address: FRISHAUF, HOLTZ, GOODMAN & CHICK, P.C.;16th Floor, 220 Fifth Avenue, New York, NY, 10017-2023, US

(73) Assignee: Olympus Corporation, Tokyo (JP)

(21) Appl. No.: 12/691,058

(22) Filed: Jan. 21, 2010

(30) Foreign Application Priority Data
Jan. 30, 2009 (JP) 2009-019376

(51) Int. Cl. B41J 2/195

(52) U.S. Cl. 347/7

(57) ABSTRACT

An inkjet printer includes a first tank for storing ink supplied to a ink jetting unit, a second tank for storing the ink that is not jetted from the ink jetting unit, and a pump for sending the ink within the second tank to the first tank, and a filling unit for filling a ink circulation path with the ink. The pump starts to be driven if the amount of ink within the first tank is smaller than a predetermined amount and the amount of ink within the second tank is equal to or larger than a predetermined amount. Additionally, the filling unit fills the ink circulation path with the ink if the amount of ink within the first tank is smaller than the predetermined amount and the amount of ink within the second tank is smaller than the predetermined amount.

### CROSS REFERENCE TO RELATED APPLICATION

This application is based upon and claims the benefit of priority from prior Japanese Application No. 2009-019376, filed Jan. 30, 2009, the entire contents of which are incorporated herein by reference.

### BACKGROUND OF THE INVENTION

1. Field of the Invention

The present invention relates to an inkjet printer including an ink circulation path for circulating ink between an ink tank for storing the ink and an inkjet head, and an ink circulation method thereof.

2. Description of the Related Art

Some inkjet printers include an ink circulation path for circulating ink between an ink tank for storing the ink and an inkjet head.

For such inkjet printers, an ink filling operation for filling the ink circulation path with the ink when the amount of ink within the ink circulation path becomes smaller than a stipulated amount due to printing is required in addition to an ink circulation operation for circulating the ink.

For example, in the inkjet printer disclosed by Japanese Laid-open Patent Publication No. 2001-219580, an ink circulating system is configured with an ink head, a first ink chamber (arranged higher than the ink head in relation to gravity), a second ink chamber (arranged lower than the ink head in relation to gravity), and a pump.

In this inkjet printer, the ink liquid surface of the first ink chamber is monitored by a liquid surface detector so as to properly perform an ink circulation operation. If the ink within the first ink chamber is determined to be insufficient, the ink within the second chamber is sent to the first ink chamber by driving the pump. In this way, the first ink chamber is filled with the ink.

Similarly, the ink liquid surface of the second ink chamber is monitored by a liquid surface detector. If the ink within the second ink chamber is determined to be insufficient, the second tank is filled with the ink from a supply ink tank.

### SUMMARY OF THE INVENTION

An inkjet printer according to the present invention includes: an ink circulation path which is configured with an ink jetting unit for jetting ink, a first tank which has a first detecting unit for detecting the amount of the stored ink, for storing the ink supplied to the ink jetting unit, a second tank which has a second detecting unit for detecting the amount of the stored ink, for storing the ink that is not jetted from the ink jetting unit, and a pump for sending the ink within the second tank to the first tank; a filling unit which is connected to the first tank or the second tank via a supply valve that can be freely opened/closed, for storing the ink with which the ink circulation path is to be filled; and a controlling unit for controlling the driving of the pump and the supply valve. In the inkjet printer, the controlling unit starts the driving of the pump if the amount of ink within the first tank is detected to be smaller than a predetermined amount by the first detecting unit and the amount of ink within the second tank is detected to be equal to or larger than a predetermined amount by the second detecting unit, stops the driving of the pump if the amount of ink within the first tank is detected to be equal to or larger than the predetermined amount by the first detecting unit and the amount of ink within the second tank is detected to be smaller than the predetermined amount by the second detecting unit, releases the supply valve if the amount of ink within the first tank is detected to be smaller than the predetermined amount by the first detecting unit and the amount of ink within the second tank is detected to be smaller than the predetermined amount by the second detecting unit, and closes the supply valve if at least one of the amount of ink within the first tank and the amount of ink within the second tank is detected to be equal to or larger than the predetermined amount.

An ink circulation method according to the present invention for use in an inkjet printer including an ink circulation path, which is configured with an ink jetting unit for jetting ink, a first tank for storing the ink supplied to the ink jetting unit, a second tank for storing the ink that is not jetted from the ink jetting unit, a pump for sending the ink within the second tank to the first tank, and a filling unit for filling the ink circulation path with the ink includes: starting the driving of the pump if the amount of ink within the first tank is smaller than a predetermined amount and the amount of ink within the second tank is equal to or larger than a predetermined amount, and stopping the driving of the pump if the amount of ink within the first tank is equal to or larger than the predetermined amount and the amount of ink within the second tank is smaller than the predetermined amount; and filling, using the filling unit, the ink circulation path with the ink only if the amount of ink within the first tank is smaller than the predetermined amount and the amount of ink within the second tank is smaller than the predetermined amount.

### BRIEF DESCRIPTION OF DRAWINGS

FIG. 1 is a schematic illustrating the outline of a configuration of an ink path of an inkjet printer according to a first embodiment;

FIG. 2 is a schematic illustrating an enlarged configuration of the ink circulation path of the inkjet printer according to the first embodiment;

FIG. 3 is an illustrating operation of units and their transition states during an ink circulation process of the inkjet printer according to the first embodiment;

FIGS. 4A to 4E are schematics illustrating the states of liquid surfaces of both tanks and the flow of ink during the ink circulation process of the inkjet printer according to the first embodiment;

FIGS. 5A to 5E are schematics illustrating the states of liquid surfaces of both tanks and the flow of ink during an ink filling operation of the inkjet printer according to the first embodiment;

FIGS. 6A to 6F are schematics illustrating the states of liquid surfaces of both tanks and the flow of ink during the ink circulation process of the inkjet printer according to the first embodiment;

FIGS. 7A to 7F are schematics illustrating the states of liquid surfaces of both tanks and the flow of ink during the ink filling operation of the inkjet printer according to the first embodiment;

FIG. 8 is a schematic illustrating the operations of units and their transition states during an ink circulation process of an inkjet printer according to a second embodiment;

FIG. 9 is a schematic illustrating the operations of units and their transition states during an ink circulation process of an inkjet printer according to a third embodiment; and

FIG. 10 is a schematic illustrating the operations of units and their transition states during an ink circulation process of an inkjet printer according to a fourth embodiment.

### DESCRIPTION OF THE PREFERRED EMBODIMENTS

Embodiments according to the present invention are described below with reference to the drawings.

### First Embodiment

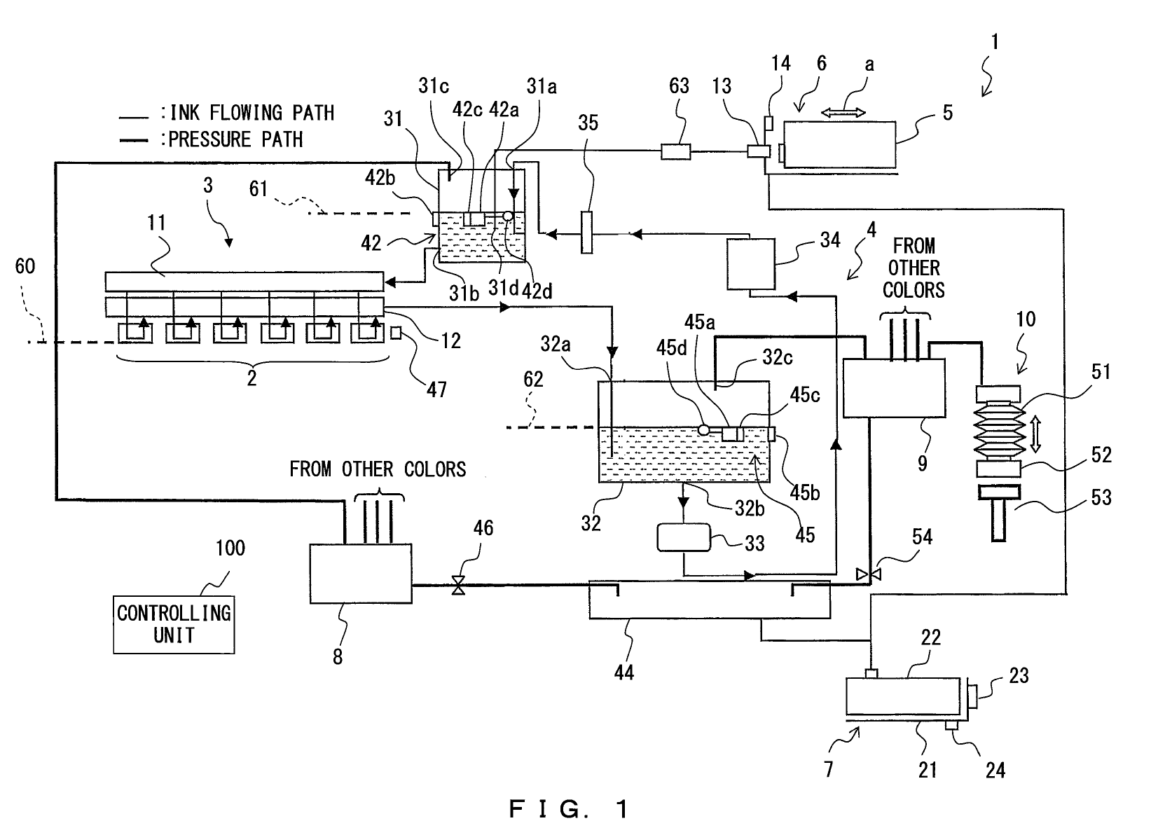

FIG. 1 is a schematic illustrating the outline of a configuration of an ink path of an inkjet printer according to a first embodiment of the present invention.

In FIG. 1, components such as a supplying unit for supplying a recording medium, a conveying unit for conveying the supplied recording medium, an ejecting unit for ejecting the recording medium on which an image is recorded, a cleaning unit for cleaning an ink head, and the like, which are included in a normal inkjet printer, are not illustrated.

The inkjet printer 1 illustrated in FIG. 1 records an image on the recording medium by using, for example, four colors of ink, such as cyan (C), magenta (M), yellow (Y), and black (K). FIG. 1 illustrates a representative configuration of an ink path related to one color of ink.

The inkjet printer 1 is mainly configured with an image recording unit 3 for recording an image on a recording medium, an ink circulation path 4 for circulating ink in the image recording unit 3, a filling unit 6 for filling the ink circulation path 4 with the ink, a waste liquid unit 7 for storing unnecessary ink or overflowing ink, and a controlling unit 100 for controlling the entire device.

The inkjet printer 1 also includes a first shared air chamber 8 having an air release valve 46 for enabling the inside of the first tank 31 to communicate with or shut off the air, a second shared air chamber 9 having an air release valve 54 for enabling the inside of the second tank 32 to communicate with or shut off the air, and a pressure adjusting unit 10 for adjusting a pressure within the second shared air chamber 9.

In FIG. 1, a configuration implemented when the four color inks are used includes ink circulation paths of four independent systems. However, the first shared air chamber 8, the second shared air chamber 9, the pressure adjusting unit 10, the waste liquid unit 7, the air release valve 46, and the air release valve 54 are shared for all the colors.

The image recording unit 3 includes an ink jetting unit 2, an ink distributor 11 for distributing the ink to the ink head 2, and an ink collector 12 for collecting the ink from the ink jetting unit 2.

The ink jetting unit 2 in this embodiment are implemented as line head by using a plurality of ink heads K1 to K6 that are shorter than the width of the recording medium, and by arranging the plurality of ink heads K1 to K6, for example, to be staggered in the width direction of the recording medium.

The ink distributor 11 is connected to the first tank 31 and the ink jetting unit 2.

The ink collector 12 is connected to the second tank 32 and the ink jetting unit 2.

A pressure within the plurality of ink heads is held to be a negative pressure (a gauge pressure of approximately −1 kPa in this embodiment) suitable for a printing operation performed when the ink is circulated. As a result, a concave meniscus is formed in the shape of a sphere inside nozzles. Then, the ink jetting unit 2 records an image on the recording medium by jetting the ink on the basis of an image signal input from an external device.

In this embodiment, the ink distributor 11 is provided. However, the first tank 31 and the ink jetting unit 2 may be directly connected. Also, the ink collector 12 is provided in this embodiment. However, the second tank 32 and the ink jetting unit 2 may be directly connected in a similar manner.

The filling unit 6 is configured with a joint unit 13 connected to an ink cartridge 5 as an ink supplying unit, which is filled with the ink, a cartridge determining unit 14 for preventing the ink cartridge 5 from being erroneously inserted and for detecting a remaining amount of the ink, and a supply valve 63 for supplying the ink from the ink cartridge 5 to the second tank 32 by being opened/closed. The ink cartridge 5 is insertable/removable into/from the joint unit 13 in a direction represented with an arrow a.

The waste liquid unit 7 includes a tank tray 21, a waste liquid tank 22 arranged above the tank tray 21, a waste ink amount detecting unit 23 for detecting the amount of waste ink stored in the waste liquid tank 22, and an overflow tank 44 in the shape of a tray, which is connected to the waste liquid tank 22.

Here, the top surface of the overflow tank 44 is open, and communicates with the air. Moreover, the overflow tank 44 is provided under the pump 33 so that it can receive the entire amount of ink even if the pump 33 is broken and the ink leaks out.

Additionally, the overflow tank 44 is connected to the first shared air chamber 8 via the air release valve 46. As a result, the first shared air chamber 8 makes a transition to an atmospheric pressure state or a sealed state by opening/closing the air release valve 46.

Furthermore, the overflow tank 44 is connected to the second shared air chamber 9 via the air release valve 54. As a result, the second shared air chamber 9 makes a transition to an atmospheric pressure state or a sealed state by opening/closing the air release valve 54.

The ink circulation path 4 is described next.

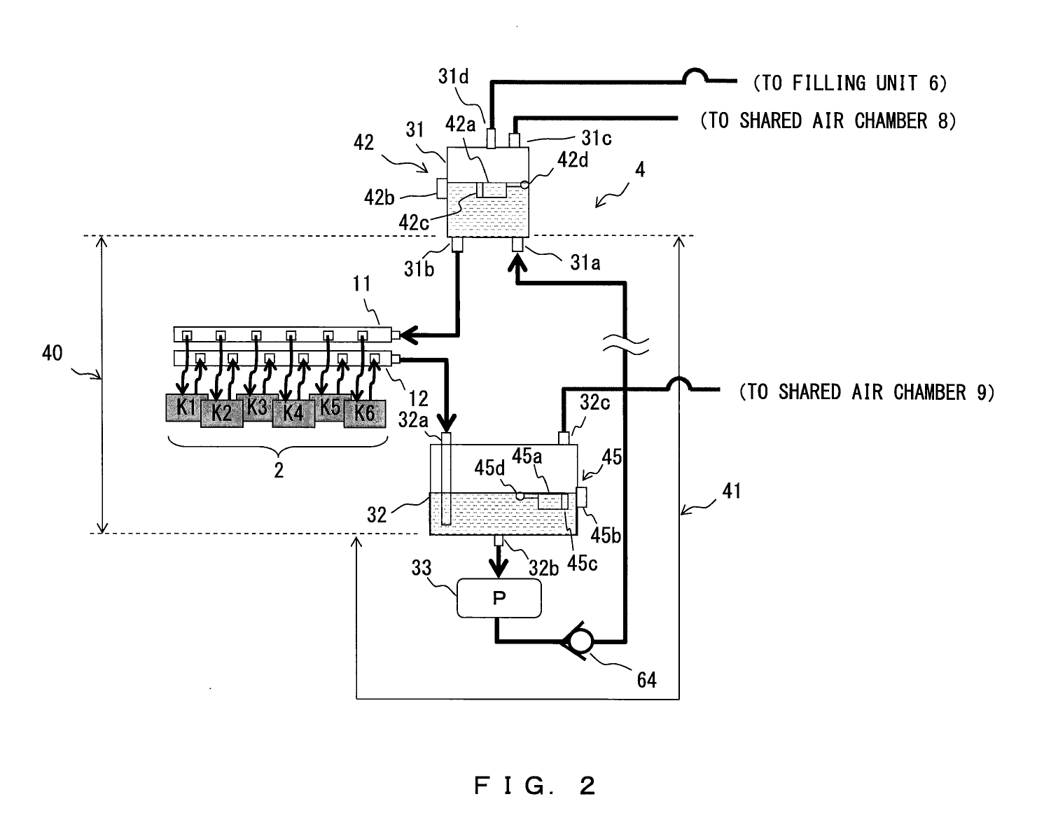

The ink circulation path 4 is configured with the first tank 31, the second tank 32, the pump 33, a heat exchanger 34, a unidirectional valve 64 (see FIG. 2), and a filter 35.

Among these components, an ink liquid surface 62 of the second tank 32, a nozzle surface 60 on which the nozzles of the ink head of ink jetting unit 2 are formed, and an ink liquid surface 61 of the first tank 31 are arranged in lower to higher positions in a vertical direction (gravitational direction) in this order.

On the ink circulation path 4, the ink flows through the first tank 31, the ink distributor 11, the ink jetting unit 2, the ink collector 12, the second tank 32, the pump 33, the unidirectional valve 64, the heat exchanger 34, and the filter 35 in this order at the time of ink circulation. On the ink circulation path 4, these components are connected with tubes so that the ink returns to the first tank 31.

The first shared air chamber 8 and the second shared air chamber 9 are respectively connected to the first tank 31 and the second tank 32 via tubes.

Here, the configuration of the ink circulation path 4 is described in further detail.

FIG. 2 is a schematic illustrating the enlarged configuration of the ink circulation path 4. Arrows in FIG. 2 represent a direction of the ink flowing in the ink circulation path 4 at the time of ink circulation. The ink circulation path 4 in this embodiment can be broadly classified into a first path 40 and a second path 41. The first path 40 is a path on which the ink flows from the first tank 31 to the second tank 32 via the ink jetting unit 2.

The second path 41 is a path on which the ink is returned by the pump 33 from an ink outlet port 32b of the second tank 32 to the first tank 31 via the unidirectional valve 64, the heat exchanger 34 (see FIG. 1), and the filter 35 (See FIG. 1).

A configuration of each of the components provided on the first path 40 is initially described in detail.

The first tank 31 is provided with an ink inlet port 31a, an ink outlet port 31b, an air port 31c, and a supply port 31d into which the ink supplied from the ink cartridge 5 flows. Moreover, a liquid surface detecting unit 42 is provided within the first tank 31 so as to hold the ink liquid surface to a predetermined height.

The liquid surface detecting unit 42 is configured with a float member 42a supported by a support shaft 42d so that the float member 42 turns within the first tank 31 in accordance with the height of the ink liquid surface, and a liquid surface position sensor 42b configured, for example, with a magnetic sensor.

The liquid surface position sensor 42b detects the magnetic force of a magnet 42c attached to the float member 42a. As a result, the liquid surface position sensor 42b detects the position of the float member 42a, namely, the ink liquid surface 61 of the first tank 31. As described above, the liquid surface detecting unit 42 is provided to hold the amount of ink stored in the first tank 31 to a predetermined amount.

The ink inlet port 31a is connected to the filter 35 (see FIG. 1) on the side of the second path 41 to be described later via a tube. The ink that passes through the filter 35 flows into the first tank 31.

The ink outlet port 31b is connected to the ink distributor 11 via a tube. The ink within the first tank 31 flows into the ink distributor 11. The ink that flows into the ink distributor 11 is nearly equally distributed to each of the ink heads of the ink jetting unit 2. The ink jetting unit 2 jets the ink from the nozzles formed on the nozzle surface 60 onto a conveyed recording medium to record an image.

The amount of ink flowing into the ink jetting unit 2 is set to be larger than the amount of ink jetted from the ink jetting unit 2. Accordingly, the ink that is not jetted from the ink jetting unit 2 flows into the ink collector 12. Then, the ink within the ink collector 12 flows into the second tank 32 via a tube.

The air port 31c is connected to the first shared air chamber 8. The first shared air chamber 8 is also connected to the air port in the first tank 31 of the other colors (see FIG. 1).

The supply port 31d is connected to the ink cartridge 5 as the ink supplying unit via the supply valve 63. The first tank 31 is filled with the ink within the ink cartridge 5 by opening the supply valve 63. Accordingly, the ink cartridge 5 is arranged higher than the first tank 31 in relation to gravity.

In this embodiment, the first tank 31 is filled with the ink within the ink cartridge 5 using a gravity drop. However, the filling of the first tank 31 is not limited to this way. The first tank 31 may be filled with the ink in whatever way it can be filled with the ink from the ink cartridge 5. For example, the first tank 31 may be filled with the ink in the ink cartridge 5 with a pump, etc.

The second tank 32 is provided with an ink inlet port 32a into which the ink flows from the ink collector 12 via a tube, an ink output port 32b for sending the ink to the pump 33, and an air port 32c connected to the second shared air chamber 9.

Additionally, a liquid surface detecting unit 45 is provided within the second tank 32 so as to hold the ink liquid surface to a predetermined height in a similar manner as in the first tank 31.

The liquid surface detecting unit 45 is configured with a float member 45a supported by a support shaft 45d so that the float member 45a turns within the second tank 32 in accordance with the height of the liquid surface of the ink, and a liquid surface position sensor 45b is configured, for example, with a magnetic sensor.

The liquid surface position sensor 45b detects a magnet 45c attached to the float member 45a. As a result, the liquid surface position sensor 45b detects the position of the float member 45a, namely, the ink liquid surface 62 of the second tank 32. As described above, the liquid surface detecting unit 45 is provided to hold the amount of ink stored in the second tank 32 to a predetermined amount.

A configuration of each of the components provided on the second path 41 is described in detail next.

As the pump 33, for example, an electromagnetic piston pump is available. The pump 33 is driven and stopped in accordance with the results of a detection made by the liquid surface detecting units 42 and 45 so that the heights of the ink liquid surfaces 61 and 62 are held within a desired range.

In this embodiment, the ink sending ability of the pump 33 is set so that an amount of ink which is larger than the amount of ink flowing into the second tank 32 can be sent to the first tank 31. In this embodiment, the electromagnetic piston pump is used as the pump 33. However, the pump 33 is not limited to this one. Any pump is available as long as the pump 33 can send an amount of ink which is larger than the amount of ink flowing into the second tank 32 to the first tank 31 as described above. A diaphragm pump, a gear pump, a tube pump, a rotary pump, or a centrifugal pump may be available as the pump 33.

The unidirectional valve 64 is connected to the ink outputting side (the side of the first tank 31) of the pump 33. The unidirectional valve 64 prevents the ink from flowing in reverse (flowing from the first tank 31 to the second tank 32) due to a difference between the heights of the ink liquid surface 61 of the first tank 31 and the ink liquid surface 62 of the second tank 32.

Namely, the unidirectional valve 64 prevents the ink from flowing in reverse on the second path 41 when the pump 33 stops.

The heat exchanger 34 (see FIG. 1) heats up or cools down the ink flowing within the ink circulation path 4. Namely, the heat exchanger 34 controls the temperature of the ink flowing within the ink circulation path 4 to be a desired temperature at which an image can be recorded. In each of the ink heads of the ink jetting unit 2 or in an ink flowing path in the vicinity thereof, a temperature sensor 47 (see FIG. 1) is arranged to control the heat exchanger 34.

The filter 35 filters foreign substances contained in the ink. This prevents the nozzles of the ink jetting unit 2 from clogging.

The pressure adjusting unit 10 is described next.

The pressure adjusting unit 10 (see FIG. 1 hereinafter) is configured with a bellows 51 for generating a negative pressure, a weight 52, and a bellows raising/lowering mechanism 53.

The bellows 51 is connected to the second shared air chamber 9 with a tube. Moreover, the weight 52 is attached to the bellows 51. The weight 52 is raised/lowered by the bellows raising/lowering mechanism 53. Namely, the bellows 51 is contracted when the bellows raising/lowering mechanism 53 goes up, and is stretched out by the weight 52 when the bellows raising/lowering mechanism 53 goes down. The position of the bellows raising/lowering mechanism 53 in the state where the bellows 51 is contracted is defined as a standby position. Moreover, the position of the bellows raising/lowering mechanism 53 in the state where the bellows 51 is stretched out is defined as a negative pressure generation position.

Here, if the air release valve 54 is closed, the air portion of the second tank 32 and the insides of the second shared air chamber 9 and the bellows 51 result in a closed space while communicating with one another. If the bellows 51 is stretched out/contracted in this state, the volume of the closed space increases/decreases. As a result, pressure within each of the second tanks 32 of all the colors simultaneously changes.

Namely, if the bellows raising/lowering mechanism 53 moves from the standby position to the negative pressure generation position (the state illustrated in FIG. 1) in the state where the air release valve 54 is closed, the bellows 51 is stretched out downward by the weight 52, and the volume of the closed space increases. As a result, a negative pressure equivalent to the gravity applied to the weight 52 is applied to the inside of the second shared air chamber 9.

The second shared air chamber 9 communicates with the second tank 32 via the tube. Accordingly, the same negative pressure as the second shared air chamber 9 is applied to the second tank 32. Moreover, since the second tank 32 communicates with the ink jetting unit 2 via the tube, the same negative pressure is also applied to the ink jetting unit 2. This negative pressure is set to a pressure suitable for printing at the time of ink circulation (for example, a nozzle pressure of approximately −1 kPa in the ink circulation state). As a result, the meniscus is formed in the nozzles of the ink heads of the ink jetting unit 2.

In the inkjet printer configured in this way, the air release valve 46 is opened to make the first tank 31 release the air when an image is recorded on a recording medium. At the same time, the air release valve 54 is closed and sealed so as to make the second tank 32 shut off the air. Then, the pressure adjusting unit 10 applies a predetermined negative pressure to the second tank 32.

In such a state, the inkjet printer 1 circulates the ink by controlling the operations of the pump 33 and the supply valve 63 in accordance with the amount of ink respectively within the first tank 31 and the second tank 32.

Namely, the ink flows through the first tank 31, the ink distributor 11, the ink jetting unit 2, the ink collector 12, the second tank 32, the pump 33, the unidirectional valve 64, the heat exchanger 34, and the filter 35 in this order, and returns to the first tank 31.

Additionally, the air release valve 46 is closed and the air release valve 54 is opened in the standby state of the inkjet printer 1.

At this time, since the second tank 32 is arranged lower than the ink jetting unit 2 in relation to gravity as described above, a meniscus is formed in the nozzles of the ink jetting unit 2 due to a hydraulic head difference. Namely, in the standby state, the ink does not drip from the ink jetting unit 2.

An ink circulation method is described next.

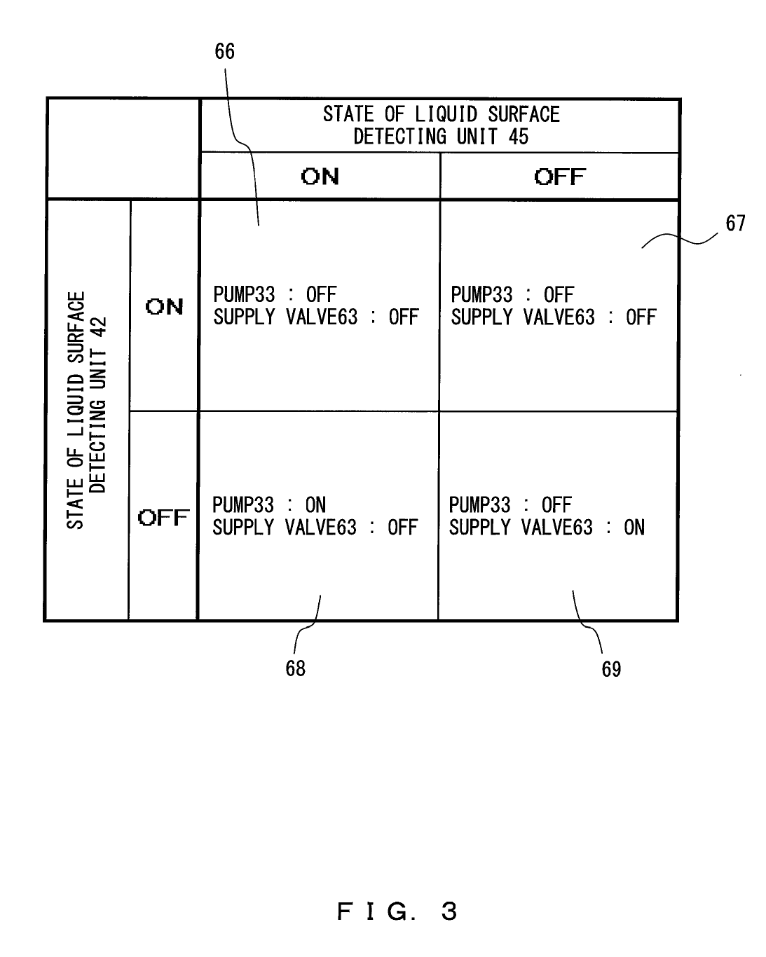

Namely, the operations of the pump 33 and the supply valve 63, which are related to the ink circulation operations and the ink filling operations, are described in detail with reference to FIG. 3.

FIG. 3 is an illustrating transition states related to the ink circulation in this embodiment. This illustrating the transition states depicts the operations of the pump 33 and the supply valve 63, which are controlled on the basis of a condition (ON or OFF) detected by the liquid surface detecting units 42 and 45 during the above described ink circulation operations.

ON in the liquid surface detecting unit 42, illustrated in FIG. 3, is the state where the ink liquid surface within the first tank 31 reaches a desired position (a desired amount of ink is stored). In other words, this is the state where the ink liquid surface within the first tank 31 is equal to or higher than the ink liquid surface 61.

ON in the liquid surface detecting unit 45, illustrated in FIG. 3, is the state where the ink liquid surface within the second tank 32 reaches a desired position (a desired amount of ink is stored). In other words, this is the state where the ink liquid surface within the second tank 32 is equal to or higher than the ink liquid surface 62.

OFF in the liquid surface detecting unit 42, illustrated in FIG. 3, is the state where the ink liquid surface within the second tank 32 does not reach the desired position (the desired amount of ink is not stored). In other words, this is the state where the ink liquid surface within the first tank 31 is lower than the ink liquid surface 61.

OFF in the liquid surface detecting unit 45, illustrated in FIG. 3, is the state where the ink liquid surface within the second tank 32 does not reach the desired position (the desired amount of ink is not stored). In other words, this is the state where the ink liquid surface within the second tank 32 is lower than the ink liquid surface 62.

ON in the pump 33, illustrated in FIG. 3, is the state where the pump 33 is driven. In other words, this is the state where the pump 33 sends the ink from the second tank 32 to the first tank 31.

OFF in the pump 33, illustrated in FIG. 3, is the state where the pump 33 is stopped. In other words, this is the state where the pump 33 does not send the ink from the second tank 32 to the first tank 31.

ON in the supply valve 63, illustrated in FIG. 3, is the state where the supply valve 63 is open. In other words, this is the state where the first tank 31 is filled with the ink from the ink cartridge 5.

OFF in the supply valve 63, illustrated in FIG. 3, is the state where the supply valve 63 is closed. In other words, this is the state where the first tank 31 is not filled with the ink from the ink cartridge 5.

The transition states illustrated in FIG. 3 are further described.

In the following description, the liquid surface detecting units 42 and 45 are referred to as a first liquid surface detecting unit 42 and a second liquid surface detecting unit 45, respectively.

Additionally, the state where the first liquid surface detecting unit 42 or the second liquid surface detecting unit 45 outputs ON is simply referred to as ON, whereas the state where the first liquid surface detecting unit 42 or the second liquid surface detecting unit 45 outputs OFF is simply referred to as OFF.

If the first liquid surface detecting unit 42 is ON, then regardless of whether the second liquid surface detecting unit 45 is ON (first state 66) or OFF (second state 67), both the pump 33 and the supply valve 63 are controlled to be OFF.

Additionally, if the first and the second liquid surface detecting units 42 and 45 are respectively OFF and ON (third state 68), the pump 33 and the supply valve 63 are controlled to be ON and OFF, respectively.

Furthermore, if both the first and the second liquid surface detecting units 42 and 45 are OFF (fourth state 69), the pump 33 and the supply valve 63 are controlled to be OFF and ON, respectively.

The operations of the pump 33 and the supply valve 63, which are related to the ink circulation operations and the ink filling operations that are performed on the basis of the above described controls, are sequentially described in accordance with changes in the liquid surfaces of the first tank 31 and the second tank 32. The ink circulation operations and the ink filling operations are controlled by the controlling unit 100.

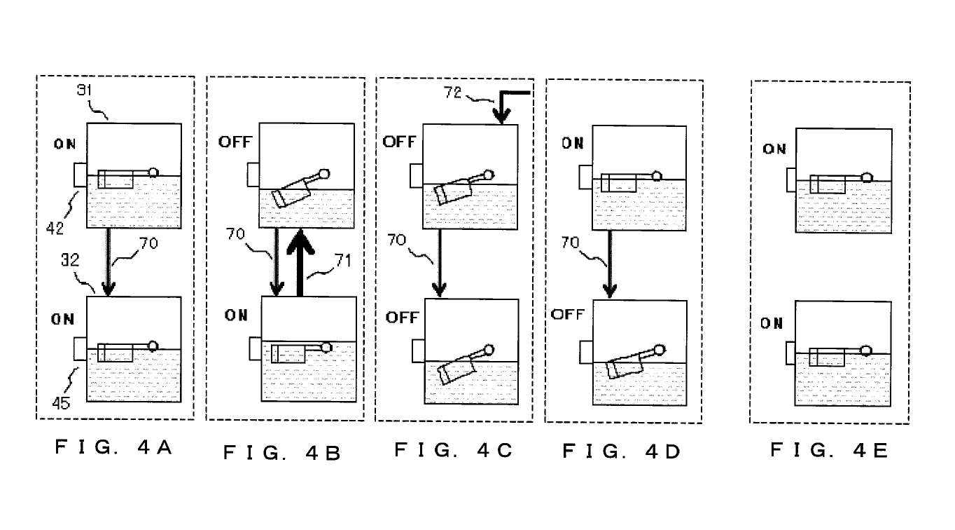

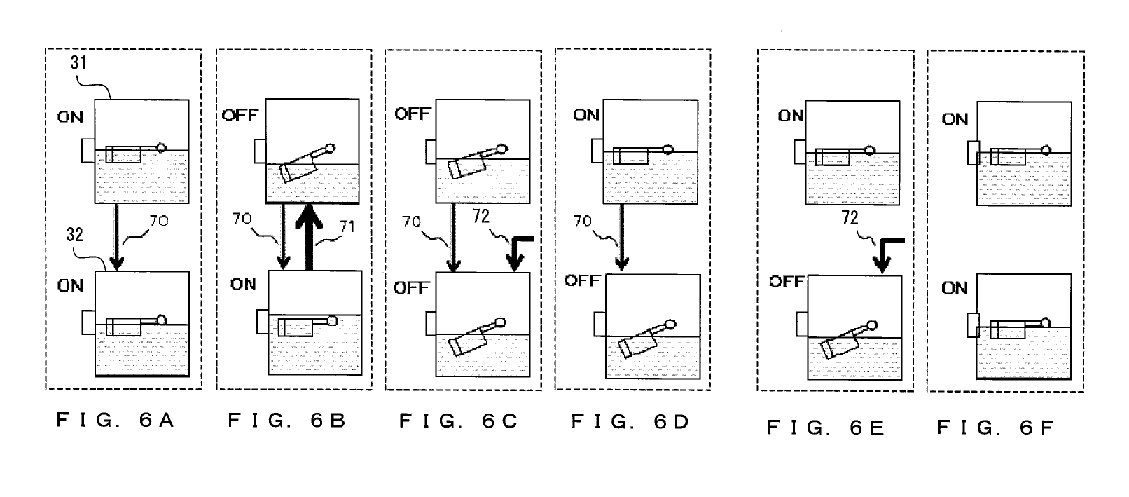

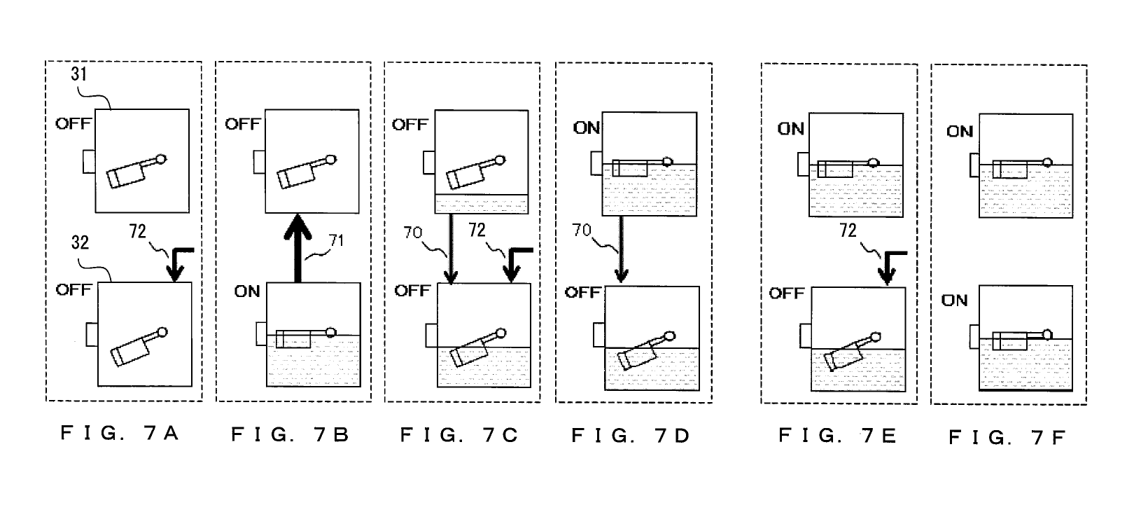

FIGS. 4A to 4E are schematics illustrating a simplified ink circulation path 4. Namely, FIGS. 4A to 4E illustrate only the simplified first tank 31 and second tank 32. Arrow 70 illustrated in FIGS. 4A to 4E indicates that the ink is sent (runs down) from the first tank 31 to the second tank 32. Arrow 71 indicates that the ink is sent from the second tank 32 to the first tank 31 by driving the pump 33. Arrow 72 indicates that the first tank 31 (or the second tank 32, see FIGS. 6 and 7 to be described later) is filled with the ink from the ink cartridge 5.

When the inkjet printer 1 is powered on and a user issues a printing instruction to the inkjet printer 1, the ink circulation operations and the ink filling operations, which are illustrated in FIGS. 4A to 4D, are started.

FIG. 4E illustrates the initial states of both of the tanks (the first tank 31 and the second tank 32, hereinafter) before the ink circulation operations is started. In these initial states, both of the tanks are filled with a desired amount of ink. Accordingly, both the first and the second liquid surface detecting units 42 and 45 are ON. Moreover, air release valve 46 is closed, whereas air release valve 54 is open.

Next, the controlling unit 100 opens air release valve 46 and closes air release valve 54 so as to start the ink circulation operations. Moreover, the controlling unit 100 applies a negative pressure to the second tank 32 with the pressure adjusting unit 10. As a result, the ink within the first tank 31 runs down into the second tank 32 via the ink jetting unit 2 as represented by the arrow 70 of FIG. 4A.

At this time, both the first and the second liquid surface detecting units 42 and 45 are ON. Therefore, this is the first transition state 66. Accordingly, both the pump 33 and the supply valve 63 are controlled to be OFF.

As time elapses, the amount of ink within the first tank 31 gradually decreases, and the amount of ink within the second tank 32 gradually increases. The states of the ink liquid surfaces of both of the tanks, which are detected by the first and the second liquid surface detecting units 42 and 45, respectively turn OFF and ON as illustrated in FIG. 4B.

The state illustrated in FIG. 4B is the third state 68 illustrated in FIG. 3. Accordingly, the pump 33 and the supply valve 63 are controlled to be ON and OFF, respectively.

As a result, the ink is sent from the second tank 32 to the first tank 31 as represented by the arrow 71 of FIG. 4B.

At this time, the pump 33 sends an amount of ink which is larger than the amount of ink running down from the first tank 31 to the second tank 32, from the second tank 32 to the first tank 31. Accordingly, the amount of ink within the second tank 32 decreases, whereas the amount of ink within the first tank 31 increases.

Here, if the ink is not jetted from the ink jetting unit 2 despite being circulated, the amount of ink flowing within the ink circulation path 4 does not vary. Accordingly, the first and the second liquid surface detecting units 42 and 45 make a transition from the state illustrated in FIG. 4B to the state illustrated in FIG. 4A. Namely, both the first and the second liquid surface detecting units 42 and 45 turn ON. As a result, both the pump 33 and the supply valve 63 are controlled to be OFF.

If the ink is not jetted from the ink jetting unit 2 despite being circulated, the states of the ink liquid surfaces of both of the tanks repeatedly make a transition between the state illustrated in FIG. 4A and that illustrated in FIG. 4B (between the first state 66 and the third state 68 of FIG. 3).

In the meantime, if the ink is jetted from the ink jetting unit 2 while being circulated, the amount of ink flowing within the ink circulation path 4 gradually decreases.

Accordingly, both the first and the second liquid surface detecting units 42 and 45 do not turn ON if the pump 33 and the supply valve 63 are respectively controlled to be ON and OFF (the state illustrated in FIG. 4B). Namely, the first and the second liquid surface detecting units 42 and 45 respectively turn ON and OFF as illustrated in FIG. 4D.

Here, the state illustrated in FIG. 4D is the second state 67 illustrated in FIG. 3. Accordingly, both the pump 33 and the supply valve 63 are controlled to be OFF.

As a result, the ink within the first tank 31 runs down into the second tank 32 via the ink jetting unit 2 as represented by the arrow 70 of FIG. 4D. Then, the first and the second liquid surface detecting units 42 and 45 respectively turn OFF and ON as illustrated in FIG. 4B.

As described above, the states of the ink liquid surfaces of both of the tanks repeatedly make a transition between the states illustrated in FIGS. 4B and 4D (between the second state 67 and the third state 68 of FIG. 3). Finally, the states of the ink liquid surfaces of both of the tanks make a transition to the state illustrated in FIG. 4C.

Namely, both the first and the second liquid surface detecting units 42 and 45 make a transition to OFF. The state of FIG. 4C is the fourth state 69 of FIG. 3.

Accordingly, the pump 33 and the supply valve 63 are controlled to be OFF and ON, respectively. As a result, the first tank 31 is filled with the ink from the ink cartridge 5 as represented by arrow 72 in addition to the operation represented by arrow 70 as illustrated in FIG. 4C.

At this time, if the amount of ink with which the first tank 31 was filled, represented by arrow 72, is larger than the amount of ink running down from the first tank 31 represented by arrow 70, then the amount of ink within the first tank 31 increases. Then, the states of the ink liquid surfaces of both of the tanks, which are respectively detected by the first and the second liquid surface detecting units 42 and 45, respectively turn ON and OFF as illustrated in FIG. 4D.

If the states of the ink liquid surfaces of both of the tanks make a transition to the state illustrated in FIG. 4D, then the first liquid surface detecting unit 42 is ON. Therefore, both the pump 33 and the supply valve 63 are controlled to be OFF regardless of whether the second liquid surface detecting unit 45 is ON (the first state 66 of FIG. 3) or OFF (the second state 67 of FIG. 3).

As a result, the ink liquid surfaces of both of the tanks make a transition to the state illustrated in FIG. 4B on the basis of the flow of the ink represented by arrow 70. In such a state, a transition is repeatedly made between the states illustrated in FIGS. 4D and 4B (between the second state 67 and the third state 68 of FIG. 3) as described above until the amount of ink within the ink circulation path is decreased by printing and a transition is made to the state illustrated in FIG. 4C.

The controlling unit 100 stops the ink circulation upon termination of the printing operation after causing the first tank 31 and the second tank 32 to enter the state of the ink liquid surfaces illustrated in FIG. 4E. As a result, the next printing operation can be started in the state where both the first tank 31 and the second tank 32 are sufficiently filled with the ink.

Specifically, the controlling unit 100 supplies the ink to the first tank 31 by intermittently opening the supply valve 63 regardless of the results of detection made by both of the liquid surface detecting units 42 and 45 while a transition is repeatedly made between the states illustrated in FIGS. 4B and 4D before stopping the ink circulation.

Then, the controlling unit 100 closes the air release valve 46 and opens the air release valve 54 at the point in time at which both of the liquid surface detecting units 42 and 45 turn ON, namely, the state illustrated in FIG. 4A.

As a result, the ink circulation is stopped in the state where both the first and the second liquid surface detecting units 42 and 45 turn ON, as illustrated in FIG. 4E. Naturally, without being limited to this process, the ink circulation operation may be stopped in any of the states illustrated in FIGS. 4A to 4D.

In this case, the pump 33 and the supply valve 63 are controlled on the basis of conditions detected by the first and the second liquid surface detecting units 42 and 45 when the printing instruction is again issued. Namely, the ink circulation operation is started by controlling the operations of the pump 33 and the supply valve 63 in accordance with any of the states (the first to the fourth states 66 to 69) illustrated in FIG. 3, and starts the ink circulation operation. As a result, the amount of ink within the ink circulation path 4 is held to be adequate, and a proper ink circulation operation can be performed.

The case where the amount of ink with which the tank was filled, represented by arrow 72, is larger than the amount of ink represented by arrow 70 in the state of FIG. 4C has been described above. However, the case in which, for example the amount of ink with which the tank was filled, represented by arrow 72, is smaller than the amount of ink represented by the arrow 70, can be similarly controlled.

Namely, the first and the second liquid surface detecting units 42 and 45 are respectively OFF and ON when a transition is made from the state of FIG. 4C to that of FIG. 4B. Therefore, the supply valve 63 is controlled to be OFF. In this state, a transition is repeatedly made between the state of FIG. 4B and that of FIG. 4D (between the second state 67 and the third state 68 of FIG. 3) until the amount of ink within the ink circulation path is decreased to the state illustrated in FIG. 4C by printing as described above.

In this way, the controlling unit 100 controls the operations of the pump 33 and the supply valve 63 on the basis of the conditions of the ink liquid surfaces, which are detected by the first and the second liquid surface detecting units 42 and 45 while the printing operation is performed.

As a result, the inkjet printer 1 can hold the amount of ink within the ink circulation path 4 to an adequate level, and a proper ink circulation operation can be performed.

The initial filling of the ink circulation path 4 with ink using the above described ink circulation method is described next.

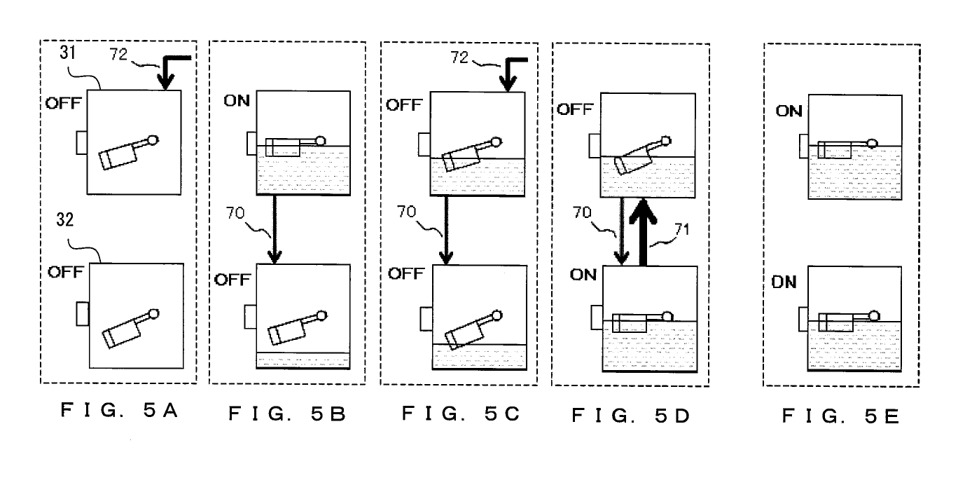

FIGS. 5A to 5E are schematics illustrating the simplified ink circulation path 4. Also in this case, FIGS. 5A to 5E illustrate only the simplified first tank 31 and second tank 32. The arrows 70, 71, and 72 represent the flow of ink as described above.

For example, at factory shipment, the ink circulation path 4 is not filled with ink. Accordingly, in the state where the ink circulation path 4 is empty of ink, an ink filling operation (initial filling) is started in the state where the air release valve 46 (see FIG. 1) and the air release valve 54 are open. The following description is provided with reference to FIG. 3 also.

FIG. 5A illustrates the initial states of both of the tanks, which are empty of ink. Accordingly, both the first and the second liquid surface detecting units 42 and 45 are OFF. Namely, this is the fourth state 69 in the schematic illustrating the transition states in FIG. 3.

Accordingly, the controlling unit 100 controls the pump 33 and the supply valve 63 to be OFF and ON, respectively. As a result, the first tank 31 is filled with the ink as represented by the arrow 72 of FIG. 5A, and a transition is made to the state illustrated in FIG. 5B after a while.

The states of the ink liquid surfaces of both of the tanks, which are illustrated in FIG. 5B and detected by the first and the second liquid surface detecting units 42 and 45, are ON and OFF, respectively. This is the second state 67 illustrated in FIG. 3. Accordingly, both the pump 33 and the supply valve 63 are controlled to be OFF.

Then, the ink within the first tank 31 runs down, whereby a transition is made to the state illustrated in FIG. 5C after a period of time. Namely, the first and the second liquid surface detecting units 42 and 45 make a transition from the ON and the OFF states of FIG. 5B to the OFF and OFF states of FIG. 5C.

Subsequent states are similar to those of the above described FIGS. 4B to 4D, and the operations of the pump 33 and the supply valve 63 are controlled in accordance with conditions detected by both of the liquid surface detecting units 42 and 45, which are illustrated in FIG. 3.

Then, when a transition starts to be repeatedly made between the third state 68 and the second state 67 of FIG. 3, the controlling unit 100 intermittently opens the supply valve 63, and fills the first tank 31 with the ink. Then, at the point in time at which a transition is made to the state illustrated in FIG. 5E, the filling with ink and the driving of the pump 33 are stopped, and the air release valve 46 is closed (in the state where the air release valve 54 is open).

As a result, the ink circulation is stopped in the state where both the first and the second liquid surface detecting units 42 and 45 turn ON as illustrated in FIG. 5E.

As a matter of course, without being limited to this process, the controlling unit 100 may stop the circulation operation in any of the states illustrated in FIGS. 5B and 5D. This is because the amount of ink within the ink circulation path 4 reaches a desired amount when a transition starts to be repeatedly made between the third state 68 and the second state 67 of FIG. 3.

At this point in time, the ink is stained on the nozzle surface of the ink heads of the ink jetting unit 2. Accordingly, the ink filling operation (initial filling) is terminated after the ink stained on the nozzle surface is removed by the cleaning unit, which is not illustrated.

As described above, the controlling unit 100 controls the operations of the pump 33 and the supply valve 63 on the basis of conditions detected by both of the liquid surface detecting units, which are illustrated in FIG. 3. As a result, the inkjet printer 1 can achieve the initial filling of the ink.

An ink circulation method used in the case where not the first tank 31 as described above but the second tank 32 is set as a portion to be filled with the ink is described next.

FIGS. 6A to 6F are schematics illustrating the simplified ink circulation path 4. Also in this case, FIGS. 6A to 6F illustrate only the simplified first and second tanks 31 and 32. The arrows 70, 71, and 72 represent the flow of the ink as described above.

When the inkjet printer 1 is powered on and a user issues a printing instruction to the inkjet printer 1, ink circulation operations and ink filling operations, which are illustrated in FIGS. 6A to 6D, are started. The following description is provided with reference to FIG. 3 also.

Similar to FIG. 4E, FIG. 6F illustrates the initial states of both of the tanks (the first tank 31 and the second tank 32) before the ink circulation operations is started. In these initial states, both of the tanks are filled with a desired amount of ink. Accordingly, the first and the second liquid surface detecting units 42 and 45 are in the ON state. Additionally, the air release valve 46 is closed, and the air release valve 54 is open.

Next, the controlling unit 100 opens the air release valve 46 and closes the air release valve 54 in order to start the ink circulation operations. Moreover, the controlling unit 100 applies a negative pressure to the second tank 32 with the pressure adjusting unit 10. As a result, the ink within the first tank 31 runs down into the second tank 32 via the ink jetting unit 2 as represented by the arrow 70 of FIG. 6A.

At this time, both the first and the second liquid surface detecting units 42 and 45 are ON. This is the first state 66 illustrated in FIG. 3. Accordingly, both the pump 33 and the supply valve 63 are controlled to be OFF.

Then, as time elapses, the amount of ink within the first tank 31 gradually decreases, and the amount of ink within the second tank 32 gradually increases. The states of the liquid surfaces of both of the tanks, which are detected by the first and the second liquid surface detecting units 42 and 45, respectively turn OFF and ON as illustrated in FIG. 6B.

The state of FIG. 6B is the third state 68 illustrated in FIG. 3. Accordingly, the pump 33 and the supply valve 63 are controlled to be ON and OFF, respectively.

As a result, the ink is sent from the second tank 32 to the first tank 31 as represented by the arrow 71 of FIG. 6B. In consequence, the amount of ink within the second tank 32 gradually decreases.

Here, if the ink is not jetted from the ink jetting unit 2 despite being circulated, the amount of ink flowing within the ink circulation path 4 does not vary. Accordingly, the states of the ink liquid surfaces of both of the tanks repeatedly make a transition between the states of FIGS. 6A and 6B (between the first state 66 and the third state 68 of FIG. 3) in a similar manner as in the above described FIG. 4.

In the meantime, if the ink is circulated and the ink is jetted from the ink jetting unit 2, the amount of ink flowing within the ink circulation path 4 gradually decreases.

Accordingly, if the pump 33 and the supply valve 63 are respectively controlled to be ON and OFF (the state of FIG. 6B), both the first and the second liquid surface detecting units 42 and 45 do not make a transition to ON, and respectively turn ON and OFF as illustrated in FIG. 6D.

Here, the state of FIG. 6D is the second state 67 of FIG. 3. Accordingly, both the pump 33 and the supply valve 63 are controlled to be OFF.

As a result, the ink within the first tank 31 runs down into the second tank 32 via the ink jetting unit 2 as represented by the arrow 70 of FIG. 6D. Then, the first and the second liquid detecting units 42 and 45 respectively turn OFF and ON as illustrated in FIG. 6B.

As described above, the states of the ink liquid surfaces of both of the tanks repeatedly make a transition between the states of FIGS. 6B and 6D (between the second state 67 and the third state 68 of FIG. 3).

Finally, the states of the ink liquid surfaces of both of the tanks result in the state illustrated in FIG. 6C. Namely, both the first and the second liquid surface detecting units 42 and 45 make a transition to the OFF state. The state of FIG. 6C is the fourth state 69 of FIG. 3. Accordingly, the pump 33 and the supply valve 63 are controlled to be OFF and ON, respectively.

As a result, the second tank 32 is filled with the ink from the ink cartridge 5 as represented by the arrow 72 in addition to the operation represented by the arrow 70 as illustrated in FIG. 6C. As described above, the amount of ink within the second tank 32 is increased by the amount of ink with which the tank is filled, represented by the arrow 72, and the amount of ink running down from the first tank 31 represented by the arrow 70.

Then, the first and the second liquid surface detecting unit 42 and 45 respectively turn OFF and ON as illustrated in FIG. 6B. Accordingly, the pump 33 and the supply valve 63 are controlled to be ON and OFF, respectively.

As a result, the ink liquid surfaces of both of the tanks make a transition to the state illustrated in FIG. 6D on the basis of the flow of the ink represented by the arrow 71. In this state, a transition is repeatedly made between the states of FIGS. 6B and 6D (between the second state 67 and the third state 68 of FIG. 3) as described above until the amount of ink within the ink circulation path is decreased to the state of FIG. 6C by printing.

Then, the controlling unit 100 stops the ink circulation after causing the states of the ink liquid surfaces of the first tank 31 and the second tank 32 to make a transition to the states of the ink liquid surfaces illustrated in FIG. 6A.

As a result, the next printing operation can be started in the state where the ink is sufficient in both the first and the second tanks 31 and 32.

Specifically, during the ink circulation, the controlling unit 100 stops the ink circulation, closes the air release valve 46, and opens the air release valve 54 at the point in time at which the first and the second liquid surface detecting unit 42 and 45 begin to make a transition to the state of FIG. 6E. Then, the second tank 32 is filled with ink by the ink cartridge 5 as represented by the arrow 72 of FIG. 6E until the second liquid surface detecting unit 45 turns ON.

As a result, both the first and the second liquid surface detecting units 42 and 45 turn ON as illustrated in FIG. 6F. As a matter of course, the controlling unit 100 may stop the circulation operation in any of the states illustrated in FIGS. 6A to 6D without being limited to this process.

In this case, the pump 33 and the supply valve 63 are controlled on the basis of conditions detected by the first and the second liquid surface detecting units 42 and 45 of both of the tanks when the printing instruction is again issued. Namely, the operations of the pump 33 and the supply valve 63 are controlled in accordance with any of the states (the first to the fourth states 66 to 69) illustrated in FIG. 3, and the ink circulation operation is started. As a result, the amount of ink within the ink circulation path 4 is held to be adequate, and a proper ink circulation operation can be performed.

Procedures for initially filling the ink circulation path 4 with the ink by using the above described ink circulation method in a configuration where the second tank 32 is filled with the ink are described next.

FIGS. 7A to 7F illustrate the simplified ink circulation path 4. Also in this case, FIGS. 7A to 7F illustrate only the simplified first tank 31 and second tank 32. The arrows 70, 71, and 72 represent the flow of the ink as described above.

For example, at factory shipment, the ink circulation path 4 is not filled with ink.

Accordingly, when the ink circulation path 4 is empty of the ink, an ink filling operation (initial filling) is started in the state where the air release valve 46 and the air release valve 54 are open. The following description is provided with reference to FIG. 3 also.

FIG. 7A illustrates the initial states of both of the tanks, which are empty of the ink. Accordingly, both the first and the second liquid surface detecting units 42 and 45 are in the OFF state. Namely, this is the fourth state 69 illustrated in FIG. 3.

Accordingly, the controlling unit 100 controls the pump 33 and the supply valve 63 to be OFF and ON, respectively. Namely, as represented by the arrow 72 of FIG. 7A, the second tank 32 is filled with the ink. As a result, the ink liquid surface of the second tank 32 makes a transition to the state illustrated in FIG. 7B.

In the state illustrated in FIG. 7B, the first and the second liquid surface detecting units 42 and 45 are OFF and ON, respectively. This is the third state 68 illustrated in FIG. 3. Accordingly, the pump 33 and the supply valve 63 are controlled to be ON and OFF, respectively.

As a result, the amount of ink within the second tank 32 decreases, and the ink liquid surfaces of both of the tanks make a transition to the state illustrated in FIG. 7C. In the state illustrated in FIG. 7C, both of the liquid surface detecting units turn OFF.

Subsequent states are similar to those of the above described FIGS. 6B to 6D, and the operations of the pump 33 and the supply valve 63 are controlled in accordance with conditions detected by both of the liquid surface detecting units 42 and 45, which are illustrated in FIG. 3.

Then, when a transition starts to be repeatedly made between the third state 68 and the second state 67 of FIG. 3, the controlling unit 100 stops the ink circulation and closes the air release valve 46 at the point in time at which a transition is made to the state of FIG. 7E.

Then, the second tank 32 is filled with the ink by the ink cartridge 5 until the second liquid surface detecting unit 45 makes a transition to ON as represented by the arrow 72 of FIG. 7E. As a result, both the first and the second liquid surface detecting units 42 and 45 turn ON as illustrated in FIG. 7F.

At this point in time, the ink is stained on the nozzle surface of the ink heads of the ink jetting unit 2. Accordingly, the ink filling operation (initial filling) is terminated after the cleaning unit, which is not illustrated, removes the ink stained on the nozzle surface.

As described above, the controlling unit 100 controls the operations of the pump 33 and the supply valve 63 on the basis of conditions detected by both of the liquid surface detecting units, which are illustrated in FIG. 3. In this way, the inkjet printer 1 can achieve the initial filling of the tank with ink.

As state earlier, according to this embodiment, it becomes possible to hold the amount of ink within the ink circulation path 4 to an adequate level and to perform proper ink circulation operations by operating the pump 33 and the supply valve 63 in accordance with the schematic illustrating the transition states in FIG. 3 not only in the case where the first tank 31 is set to be filled with the ink supplied from the ink cartridge 5 but also in the case where the second tank 32 is set to be filled with the ink.

In this embodiment, the ink jetting unit is implemented as line head. However, the ink jetting unit is not limited to the line head. Namely, the ink jetting unit may be serial head.

Additionally, the first tank is arranged higher than the ink jetting unit in relation to gravity, and the second tank is arranged lower than the ink jetting unit in relation to gravity. However, the arrangements of the first and the second tanks are not limited to these positions.

In short, the inkjet printer may be configured in whatever way as long as the two tanks are provided, and ink is circulated between the tanks. Also in such a case, proper ink circulation operations and ink filling operations can be performed by performing the controls illustrated in FIG. 3 on the basis of conditions detected by the liquid surface detecting units that are respectively provided in the two tanks.

### Second Embodiment

A second embodiment according to the present invention is described next. In the following embodiment, some of the operations of the pump 33 are different.

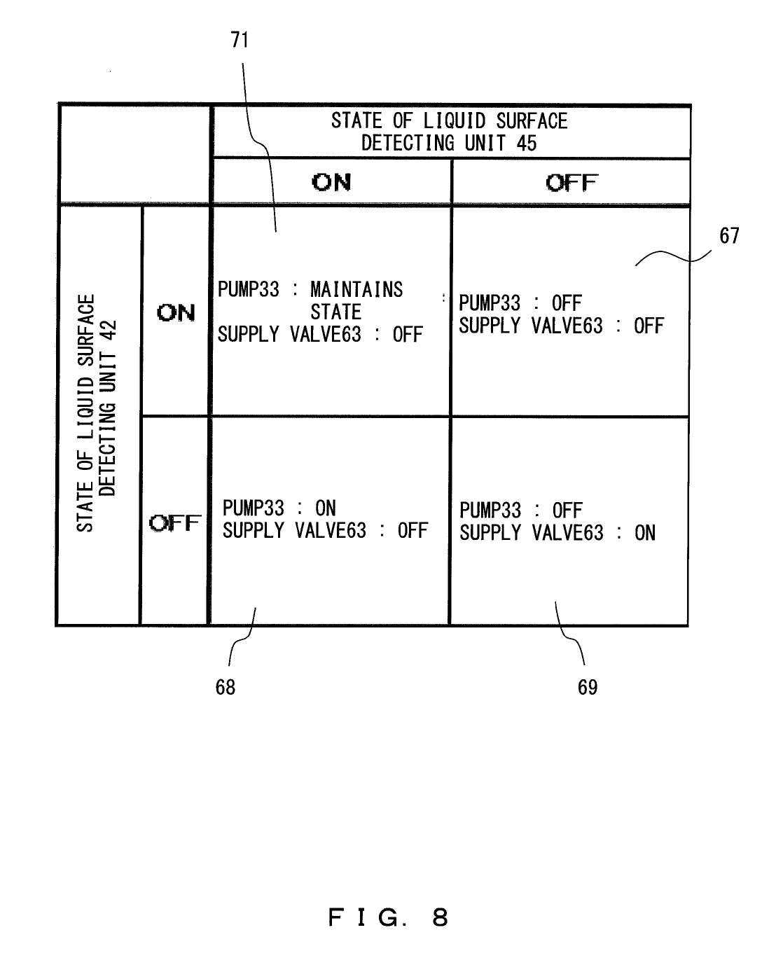

FIG. 8 illustrates the operations of units and their transition states during ink circulation operations in an inkjet printer according to the second embodiment. The second embodiment is different from the first embodiment in the case where both the first and the second liquid surface detecting units 42 and 45 are ON.

Namely, in FIG. 3, both the pump 33 and the supply valve 63 are controlled to be OFF in the state where both the first and the second liquid surface detecting units 42 and 45 are ON.

However, in the second embodiment, the state where both the first and the second liquid surface detecting units 42 and 45 are ON is a state 71 in which the supply valve 63 is controlled to be OFF and the pump 33 is controlled to maintain its state.

“To maintain a state” referred to in the second embodiment (similar to third and fourth embodiments to be described below) means that the state where the operation of the pump 33 before a transition is made to the state 71 is continued.

For example, if both of the liquid surface detecting units 42 and 45 turn ON in the ON state of the operation of the pump 33, the supply valve 63 is controlled to be OFF in a similar manner as in FIG. 3, but the pump 33 is controlled to maintain the ON state.

Alternatively, if both of the liquid surface detecting units 42 and 45 turn ON in the OFF state of the operation of the pump 33, the supply valve 63 is controlled to be OFF, and also the pump 33 is controlled to maintain the OFF state.

Controls performed for the operations of the pump 33 and the supply valve 63 when the first and the second liquid surface detecting units 42 and 45 are respectively ON and OFF, OFF and ON, and OFF and OFF are similar to those in FIG. 3. By performing controls in this way, similar effects as those in the above described first embodiment can be achieved.

### Third Embodiment

A third embodiment according to the present invention is described next.

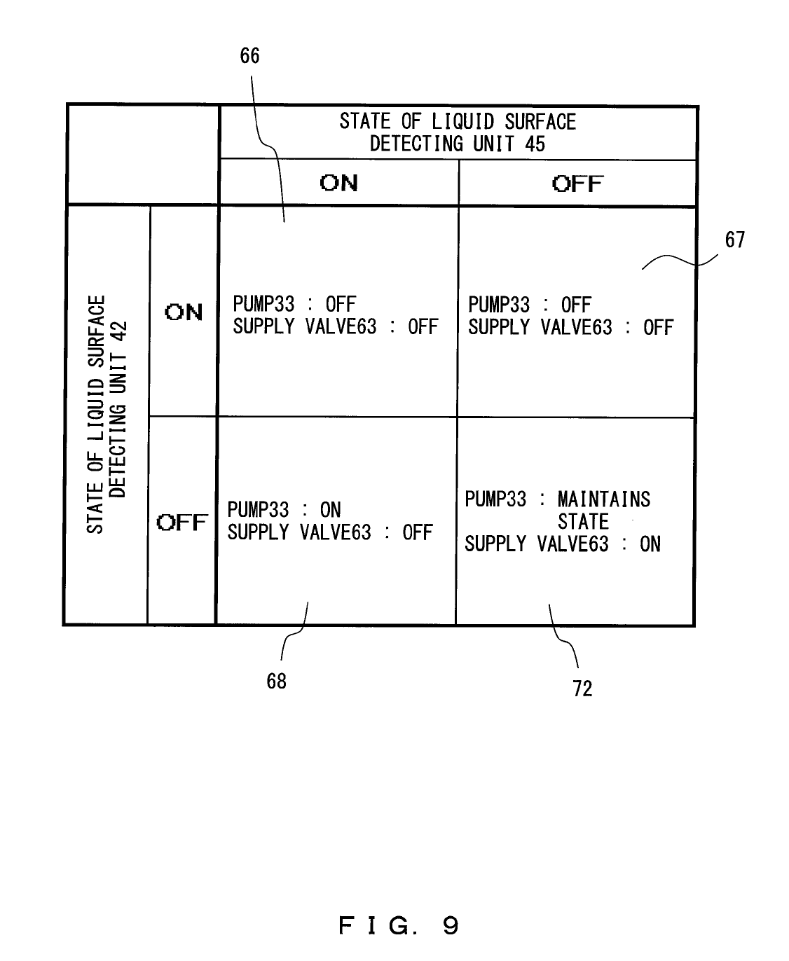

FIG. 9 is a schematic illustrating the operations of units and its transition states during ink circulation operations in an inkjet printer according to the third embodiment.

The third embodiment is different from the first embodiment in the state where both the first and the second liquid surface detecting units 42 and 45 are OFF.

Namely, in FIG. 3, the state where both the first and the second liquid surface detecting units 42 and 45 are OFF is the fourth state 69, in which the pump 33 and the supply valve 63 are controlled to be OFF and ON, respectively.

However, in the third embodiment, the state where both the first and the second liquid surface detecting units 42 and 45 are OFF is a state 72 in which the supply valve 63 is controlled to be ON and the pump 33 is controlled to maintain its state.

For example, if both of the liquid surface detecting units 42 and 45 turn OFF in the ON state of the operation of the pump 33, the supply valve 63 is controlled to be ON, and the pump 33 is controlled to maintain the ON state.

Alternatively, if both of the liquid surface detecting units 42 and 45 turn OFF in the OFF state of the operation of the pump 33, the supply valve 63 is controlled to be ON, and the pump is controlled to maintain the OFF state.

Controls performed for the operations of the pump 33 and the supply valve 63 in the state where the first and the second liquid surface detecting units 42 and 45 are respectively ON and ON, ON and OFF, and OFF and ON are similar to those in FIG. 3. By performing controls in this way, similar effects as those in the above described first embodiment can be achieved.

### Fourth Embodiment

A fourth embodiment according to the present invention is described next.

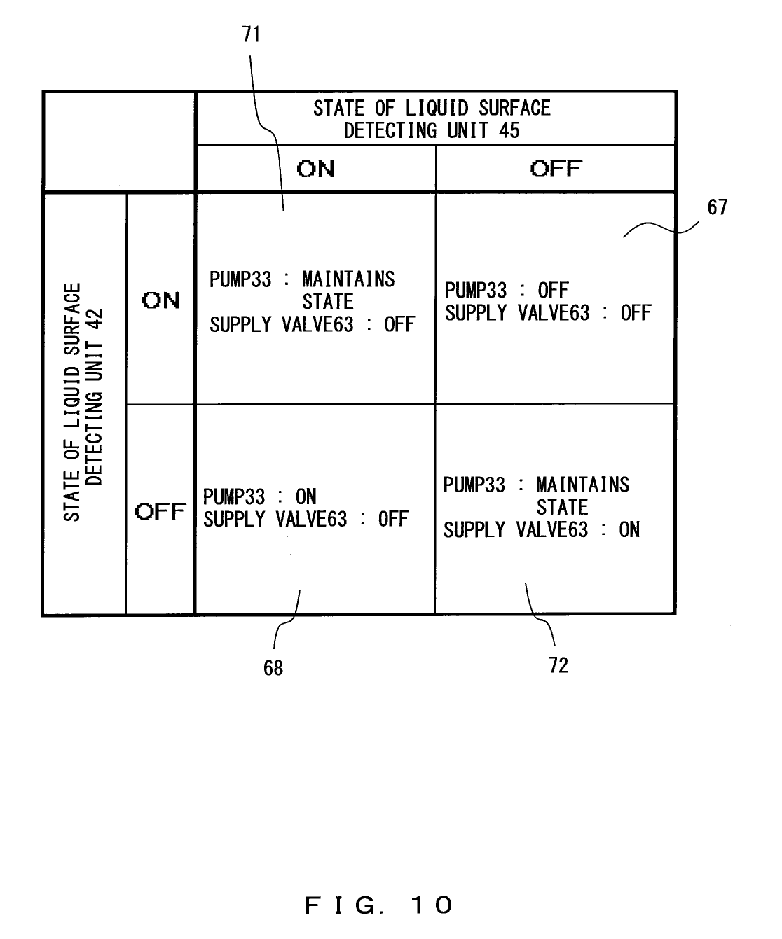

FIG. 10 illustrates operations of units and their transition states during ink circulation operations in an inkjet printer according to the fourth embodiment.

In the fourth embodiment, control is performed in a manner different from the first embodiment in the case where the first and the second liquid surface detecting units 42 and 45 are respectively ON and ON, and OFF and OFF.

Namely, in FIG. 3, the state where both the first and the second liquid surface detecting units 42 and 45 are ON is the first state 66, in which both the pump 33 and the supply valve 63 are controlled to be OFF.

However, in the fourth embodiment, the state where both the first and the second liquid surface detecting units 42 and 45 are ON is the state 71 in which the supply valve 63 is controlled to be OFF and the pump 33 is controlled to maintain its state. This is the same as the state 71 of the second embodiment.

Additionally, in FIG. 3, the state where both the first and the second liquid surface detecting units 42 and 45 are OFF is the fourth state 69, in which the pump 33 and the supply valve 63 are controlled to be OFF and ON, respectively.

However, in the fourth embodiment, the state where both the first and the second liquid surface detecting units 42 and 45 are OFF is the state 72 in which the supply valve 63 is controlled to be ON and the pump 33 is controlled to maintain its state. This is the same as the state 72 of the third embodiment.

Controls performed for the operations of the pump 33 and the supply valve 63 in the state where the first and the second liquid surface detecting units 42 and 45 are respectively ON and OFF, and OFF and ON are similar to those in FIG. 3. By performing controls in this way, similar effects as those in the above described first embodiment can be achieved.

What is claimed is:

1. An inkjet printer, comprising:
an ink circulation path including
an ink jetting unit for jetting ink,
a first tank which has a first detecting unit for detecting an amount of the stored ink, for storing the ink supplied to the ink jetting unit,
a second tank which has a second detecting unit for detecting an amount of the stored ink, for storing the ink that is not jetted from the ink jetting unit, and
a pump for sending the ink within the second tank to the first tank;
a filling unit which is connected to the first tank or the second tank via a supply valve that can be freely opened/closed, for storing the ink with which the ink circulation path is to be filled; and
a controlling unit for controlling driving of the pump and the supply valve, wherein
the controlling unit starts the driving of the pump if the amount of ink within the first tank is detected to be smaller than a predetermined amount by the first detecting unit and the amount of ink within the second tank is detected to be equal to or larger than a predetermined amount by the second detecting unit, stops the driving of the pump if the amount of ink within the first tank is detected to be equal to or larger than the predetermined amount by the first detecting unit and the amount of ink within the second tank is detected to be smaller than the predetermined amount by the second detecting unit, opens the supply valve if the amount of ink within the first tank is detected to be smaller than the predetermined amount by the first detecting unit and the amount of ink within the second tank is detected to be smaller than the predetermined amount by the second detecting unit, and closes the supply valve if at least one of the amount of ink within the first tank and the amount of ink within the second tank is detected to be equal to or larger than the predetermined amount.

2. The inkjet printer according to claim 1, wherein
the controlling unit stops the driving of the pump if the amount of ink within the first tank is detected to be smaller than the predetermined amount by the first detecting unit and the amount of ink within the second tank is detected to be smaller than the predetermined amount by the second detecting unit.

3. The inkjet printer according to claim 1, wherein
the controlling unit stops the driving of the pump if the amount of ink within the first tank is detected to be equal to or larger than the predetermined amount by the first detecting unit and the amount of ink within the second tank is detected to be equal to or larger than the predetermined amount by the second detecting unit.

4. The inkjet printer according to claim 2, wherein
the controlling unit stops the driving of the pump if the amount of ink within the first tank is detected to be equal to or larger than the predetermined amount by the first detecting unit and the amount of ink within the second tank is detected to be equal to or larger than the predetermined amount by the second detecting unit.

5. An inkjet printer, comprising:
an ink circulation path including
an ink head which has a nozzle surface on which a plurality of nozzles are formed, for jetting ink from the plurality of nozzles,
a first tank which has a first detecting unit for detecting an amount of the stored ink and is arranged higher than the nozzle surface in relation to gravity, for storing the ink supplied to the ink head,
a first air release valve for making the first tank communicate with or shut off an air,
a second tank which has a second detecting unit for detecting an amount of the stored ink and is arranged lower than the nozzle surface in relation to gravity, for storing the ink that is not jetted from the ink head,
a second air release valve for making the second tank communicate with or shut off the air, and
a pump for sending the ink within the second tank to the first tank;
a filling unit which is connected to the first tank or the second tank via a supply valve that can be freely opened/closed, for storing the ink with which the ink circulation path is to be filled;
a pressure adjusting unit for applying a predetermined negative pressure to the second tank when the second tank is made to shut off the air by the second air release valve; and
a controlling unit for controlling driving of the first air release valve, the second air release valve, the pressure adjusting unit, the pump, and the supply valve, wherein
the controlling unit adjusts a magnitude of the negative pressure applied by the pressure adjusting unit to the second tank by releasing the first air release valve and by closing the second air release valve when the ink circulates within the ink circulation path, starts the driving of the pump if the amount of ink within the first tank is detected to be smaller than a predetermined amount by the first detecting unit and the amount of ink within the second tank is detected to be equal to or larger than a predetermined amount by the second detecting unit, stops the driving of the pump if the amount of ink within the first tank is detected to be equal to or larger than the predetermined amount by the first detecting unit and the amount of ink within the second tank is detected to be smaller than the predetermined amount by the second detecting unit, releases the supply valve if the amount of ink within the first tank is detected to be smaller than the predetermined amount by the first detecting unit and the amount of ink within the second tank is detected to be smaller than the predetermined amount by the second detecting unit, and closes the supply valve if at least one of the amount of ink within the first tank and the amount of ink within the second tank is detected to be equal to or larger than the predetermined amount.

6. The inkjet printer according to claim 5, wherein
the controlling unit stops the driving of the pump if the amount of ink within the first tank is detected to be smaller than the predetermined amount by the first detecting unit and the amount of ink within the second tank is detected to be smaller than the predetermined amount by the second detecting unit.

7. The inkjet printer according to claim 5, wherein
the controlling unit stops the driving of the pump if the amount of ink within the first tank is detected to be equal to or larger than the predetermined amount by the first detecting unit and the amount of ink within the second tank is detected to be equal to or larger than the predetermined amount by the second detecting unit.

8. The inkjet printer according to claim 6, wherein
the controlling unit stops the driving of the pump if the amount of ink within the first tank is detected to be equal to or larger than the predetermined amount by the first detecting unit and the amount of ink within the second tank is detected to be equal to or larger than the predetermined amount by the second detecting unit.

9. An ink circulation method for use in an inkjet printer including an ink circulation path, which is configured with an ink jetting unit for jetting ink, a first tank for storing the ink supplied to the ink jetting unit, a second tank for storing the ink that is not jetted from the ink jetting unit, a pump for sending the ink within the second tank to the first tank, and a filling unit for filling the ink circulation path with the ink, comprising:
starting driving of the pump if an amount of ink within the first tank is smaller than a predetermined amount and an amount of ink within the second tank is equal to or larger than a predetermined amount, and stopping the driving of the pump if the amount of ink within the first tank is equal to or larger than the predetermined amount and the amount of ink within the second tank is smaller than the predetermined amount; and
filling, using the filling unit, the ink circulation path with the ink only if the amount of ink within the first tank is smaller than the predetermined amount and the amount of ink within the second tank is smaller than the predetermined amount.

10. The ink circulation method according to claim 9, further comprising
stopping the driving of the pump if the amount of ink within the first tank is smaller than the predetermined amount and the amount of ink within the second tank is smaller than the predetermined amount.

11. The ink circulation method according to claim 9, further comprising
stopping the driving of the pump if the amount of ink within the first tank is equal to or larger than the predetermined amount and the amount of ink within the second tank is equal to or larger than the predetermined amount.

12. The ink circulation method according to claim 10, further comprising
stopping the driving of the pump if the amount of ink within the first tank is equal to or larger than the predetermined amount and the amount of ink within the second tank is equal to or larger than the predetermined amount.
